(19) United States
(12) Patent Application Publication
(10) Pub. No.: US 2016/0203670 A1
(43) Pub. Date: Jul. 14, 2016

(54) SYSTEMS AND METHODS FOR A FANTASY LEGEND SPORTS SLOT MACHINE

(71) Applicant: MATTHEW E. FORD, West Milford, NJ (US)

(72) Inventor: MATTHEW E. FORD, West Milford, NJ (US)

(21) Appl. No.: 14/595,636

(22) Filed: Jan. 13, 2015

(51) Int. Cl. G07F 17/32; G07F 17/34

(52) U.S. Cl. CPC G07F 17/3213; G07F 17/34

(57) ABSTRACT

Systems and methods for a legend sport slot machine apply a database containing games played by a player of a sport. Each player in the database has an image in the database. Each image has a plurality of identifiers, including a name of the player, a team name for the player, a game position for the player, a unique game of the player in a plurality of unique games, a score for the player in the unique game, a date the unique game was played and a result of the unique game. The slot machine is activated by a gamer to randomly generate an image for each of a plurality of windows on a display screen, each image is associated with one of the plurality of unique games. A gamer predicts a payline in the plurality of windows and a score outcome. A payout takes place when the outcome on the payline matches a prediction.

### BACKGROUND

A conventional slot machine is a gambling machine with usually three or more reels, each reel containing a plurality of symbols or images. The reels spin, usually in a vertical plane, after activating the machine, either by pushing a button or pulling a handle or by other activating devices. The spinning of the three or more reels appears to be independent. After a period of time the spinning of each reel stops. At that time at least one symbol or image of each reel is visible, usually through a marking or a window. Each of the images or symbols of the reels are displayed on a, usually, horizontal line. When the displayed symbols or images on a line match to a predetermined pattern, the machine provides a pay-out. The pay-out may be in coins, money, tokes or points or any other form of reward.

In general, the rotation of the reels cannot be influenced by a gamer and the displayed line of symbols or images is the result of a random or seemingly random or pseudo-random process.

Present day slot machines are mostly computerized devices, wherein the reels and the rotation thereof are simulated by a processor and images of the simulated rotating and stopped reels are shown on a display screen. In accordance with an aspect of the present invention a processor based slot machine with an activated reel displays preferably at least 5 images per second in a reel window and more preferably at least 10 images per second and most preferably at least 15 images per second in a reel window. In some embodiments of slot machines the number of reels has increased and so has the number of lines that are displayed. For instance, in addition to a single line of symbols or images multiple lines of images and symbols are displayed. This allows multiple winning lines or paylines for a gamer. So rather than a single horizontal line of three symbols or images, a computerized slot machine may have three or more (simulated) reels of which for instance 3 images or symbols are displayed as a column. This allows a display of an array of symbols or images and a plurality of different paylines.

Slot machines, including computerized slot machines, are often machines wherein winning statics for a gamer playing the machine are entirely determined by chance based on settings of the machine. It would be more inviting and satisfying if knowledge of a gamer on a subject, such as a sport, would positively influence the winning statistics for a gamer.

Accordingly, novel and improved slot machines that improve a chance of winning of a gamer based on knowledge of a subject, such as a sport, are required.

### SUMMARY OF THE INVENTION

In accordance with one or more aspects of the present invention methods and systems for a legend sports slot machine are provided wherein the legend is a player in the sport who has a performance record in a played game in the past.

In accordance with an aspect of the present invention, a gaming device is provided, comprising a memory, that stores a first plurality of images, each image of the first plurality of images is representative of a single player in a sport, and instructions, a processor, that executes instructions retrieved from the memory, an input that provides prediction data to the processor and that activates the gaming device, a display screen that is controlled by the processor to display a second plurality of images arranged in an array of rows and columns, the second plurality of images on the display screen selected by the processor from the first plurality of images, the display of the second plurality of images being initiated by an activation of the gaming device, each single player is associated with a plurality of parameters that includes: a name of the single player in the sport, a plurality of games in the sport wherein the single player has played, a position of the single player in the plurality of games, a game score of the single player in a game in the plurality of games and a date that the game was played, each image in the second plurality of images is selected randomly from the first plurality of images and each randomly selected image is provided with a game randomly selected by the processor from the plurality of games in the sport wherein the single player has played, a prediction of an outcome score that is provided to the processor and that is based on a predicted arrangement of a subset of the second plurality of images in the array, a determined outcome score determined by the processor, based on the game score of each single player of the images in the subset of the second plurality of images; and a winning determined by the processor based on a comparison of the prediction of the outcome score with the determined outcome score.

In accordance with another aspect of the present invention, a gaming device is provided, wherein the outcome score is determined by combining the game score of the single player in each image in the arrangement of the subset of the second plurality of images in the array.

In accordance with yet another aspect of the present invention, a gaming device is provided, wherein the outcome score is determined by comparing at least one of the game scores in the arrangement of the subset of the second plurality of images in the array with the prediction of the outcome score.

In accordance with yet another aspect of the present invention, a gaming device is provided, wherein a winning combination is determined when all images in the arrangement of the subset of the second plurality of images in the array are images of the same single player.

In accordance with yet another aspect of the present invention, a gaming device is provided, wherein a winning combination is determined when all images in the arrangement of the subset of the second plurality of images in the array are images of single players in a same team.

In accordance with yet another aspect of the present invention, a gaming device is provided, wherein a winning combination is determined when all images in the arrangement of the subset of the second plurality of images in the array are images of single players in a same playing position.

In accordance with yet another aspect of the present invention, a gaming device is provided, wherein an array of rows and columns has at least 3 columns.

In accordance with yet another aspect of the present invention, a gaming device is provided, wherein an array of rows and columns has at least 5 columns.

In accordance with yet another aspect of the present invention, a gaming device is provided, wherein the arrangement of the subset of the second plurality of images in the array is formed by at least one image location in each column.

In accordance with yet another aspect of the present invention, a gaming device is provided, wherein the arrangement of the subset of the second plurality of images in the array is formed by at least two image locations in at least one column.

In accordance with yet another aspect of the present invention, a gaming device is provided, wherein the first plurality of images is arranged in a plurality of reels of images, each reel representing images that are enabled to be displayed in a column in the array.

In accordance with yet another aspect of the present invention, a gaming device is provided, wherein the gaming device is a stand-alone slot machine.

In accordance with yet another aspect of the present invention, a gaming device is provided, wherein the gaming device is a smartphone.

In accordance with yet another aspect of the present invention, a gaming device is provided, further comprising an actuator that is activated when an action on the display screen is started.

In accordance with a further aspect of the present invention, a slot machine is provided, comprising a memory, that stores a first plurality of images, each image of the first plurality of images is representative of a single player in a sport, and instructions, a processor, that executes instructions retrieved from the memory, an input, the input provides prediction data to the processor and the input activates the slot machine to execute a slot machine game, a display screen that is a touch screen that is controlled by the processor to display a second plurality of images arranged in an array of rows and columns, the second plurality of images on the display screen selected by the processor from the first plurality of images, the display of the second plurality of images being initiated by an activation of the gaming device, each single player is associated on the memory with a plurality of parameters that includes: a name of the single player in the sport, a plurality of games in the sport wherein the single player has played, a position of the single player in the plurality of games, a game score of the single player in a game in the plurality of games and a date that the game was played, each image in the second plurality of images is selected randomly by the processor from the first plurality of images and each randomly selected image is provided by the processor with a game that is randomly selected by the processor from the plurality of games in the sport wherein the single player has played, a prediction of an outcome score that is based on a predicted arrangement of a subset of the second plurality of images in the array and that is provided by the input prior to the activation, a determined outcome score that is determined by the processor based on the game score of each single player of the images in the subset of the second plurality of images and a winning that is based on a comparison of the prediction of the outcome score with the determined outcome score.

In accordance with yet a further aspect of the present invention, a slot machine is provided, wherein the first plurality of images is arranged in a plurality of reels of images, each reel representing images that are enabled to be displayed in a column in the array.

In accordance with yet a further aspect of the present invention, a slot machine is provided, further comprising an actuator that is activated when a reel in the plurality of reels stops rotating.

In accordance with yet a further aspect of the present invention, a slot machine is provided, wherein the slot machine is a smartphone.

In accordance with yet another aspect of the present invention a method for operating a slot machine is provided, comprising inputting on an input of a processor prediction data, activating the processor to perform the slot machine, randomly selecting by the processor from a first plurality of images a second plurality of images that are displayed on the touch screen arranged in an array of rows and columns, each image of the first plurality of images represents a single player in a sport and is associated with a plurality of parameters that includes: a name of the single player in the sport, a plurality of games in the sport wherein the single player has played, a position of the single player in the plurality of games, a game score of the single player in a game in the plurality of games and a date that the game was played, the processor providing each randomly selected image in the second plurality of images with a game randomly selected by the processor from the plurality of games in the sport wherein the single player of the randomly selected image has played, the processor accepting, prior to the activation, a prediction of an outcome score that is based on a predicted arrangement of a subset of the second plurality of images in the array, the processor determining an outcome score, based on the game score of each single player of the images in the subset of the second plurality of images and the processor determining a winning based on a comparison of the prediction of the outcome score with the outcome score.

In accordance with yet another aspect of the present invention a method for operating a slot machine is provided, wherein the outcome score is determined by combining the game score of the single player in each image in the arrangement of the subset of the second plurality of images in the array.

### DESCRIPTION OF DRAWINGS

FIGS. 1, 2, 3 and 4 illustrate a sports slot machine in accordance with various aspects of the present invention.

FIG. 5 illustrates a network in accordance with various aspects of the present invention.

FIG. 6 illustrates a user interface on a mobile computing device for a sports legend slot machine in accordance with one or more aspects of the present invention; and

FIG. 7 illustrates a computing device for a legend sports slot machine to execute and perform instructions in accordance with an aspect of the present invention.

### DESCRIPTION

While specific embodiments are disclosed of systems and methods, the invention is intended to extend to its broadest aspects. Thus, if limiting language is used when describing an embodiment that language is not intended to limit the broad aspects of the various inventions described herein.

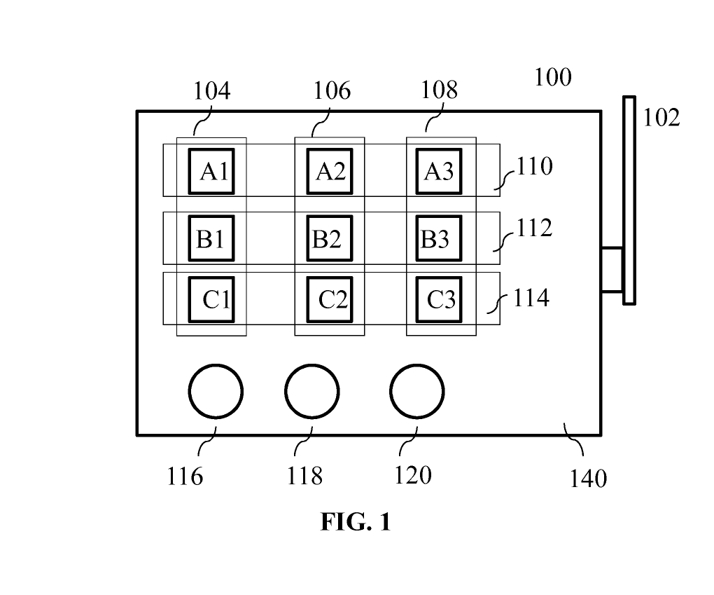

FIG. 1 illustrates in diagram a multi-window computerized slot machine 100, which may be a simulated multi-reel, multi-line slot machine. The term slot machine will be used herein to indicate and mean a computerized slot machine, wherein symbols and images that determine a game result, are generated on a computer display or any other display screen by a processor or electronic circuit. The slot machine has a display or touch screen with display 140 that can display images, such as the simulated reels and any input device such as buttons 116, 118 and 120, or a touch screen keyboard that is not shown, or any other real or touchscreen based input device.

In one embodiment of the present invention, the slot machine 100 is a simulated or virtual reel machine. In that case the slot machine 100 has images of rotating reels, in this case 3 vertical parallel reels 104, 106 and 108, each having a series of symbols or images. The reels can be simulated to rotate, for instance by activating or pulling a handle 102, as in the conventional slot machines, or by activating one or more of the input devices or locations on the screen 140. The rotating reels are simulated by displaying images of a reel in different stages of rotation and which are for instance retrieved from a memory or are created from individual images or symbols. By displaying the images rapidly, for instance at a speed of 15 images per second, or higher at at least 30 images per second an impression of rotating reels may is provided.

When the virtual reels are rotating, the processor may generate an impression of rotation of the reels showing symbols and images moving past the windows on the screen. When the reels have stopped rotating, the screen displays three symbols in a vertical column for each reel. Each symbol has its own window. Accordingly, reel 104 shows windows A1, B1 and C1 in a column; reel 106 shows windows A2, B2, C2 in a column; and reel 108 shows symbols A3, B3 and C3 in a column. The windows A1, A2 and A3 form the row 110; the windows B1, B2 and B3 form the row 112; and the windows C1, C2 and C3 form the row 114. Accordingly, a 3 by 3 array of rows and columns is formed by the windows.

In a second embodiment of the present invention no reels are simulated in slot machine 100. A reel implies a physical device with a certain order of symbols or images. It may be that one wants to change the order of symbols or images or even the total number of symbols or images during play. In that case, after activating the device 100, each window in the array displays a symbol or an image. However, these symbols or images may be independent in order. On a reel symbols or images A1 and C1 are adjacent to B1. However in this second embodiment of the present invention such a relationship may not exist.

In the second embodiment of the present invention as illustrated in FIG. 1 each symbol or image of a window in the array is determined individually. This further allows an unrestricted expansion of the number of rows and columns with windows beyond the 3 by 3 array as shown in FIG. 1.

In accordance with an aspect of the present invention, the screen 140 is configured to generate an array of symbols or images arranged in an array of windows W_{n,m}, wherein n indicates the number of rows and m indicates the number of columns. Each window is identified by W_{i,j} wherein i indicates the row (with i can be 1, . . . , n) and j indicates the column (where j can be 1, . . . , m). In general, the arrays of windows applied herein are square arrays with equal number of rows and columns or m=n. In a further embodiment of the present invention the number of rows is not equal to the number of columns. For instance, the number of rows can be greater than the number of columns. In that case, if a payline is determined by the number of columns matching a predetermined pattern of symbols or images, provides an increased chance to achieve a certain payline. Conversely, a number of rows is provided that is smaller than the number of columns. In a further embodiment of the present invention a window array of 5 by 5 windows is provided. In yet a further embodiment of the present invention a window array of 10 by 10 windows is provided.

A payline on a slot machine is generally a series of windows that show a required pattern of symbols or images. More specifically, a conventional payline in slot machines is a payline across the array of windows. In terms of reels: each reel should have one required symbol in one of its columns. Vertical paylines in such a case would not exist, as presumably, required symbols would not be adjacent on a single reel. Such a requirement is no longer a physical limitation in an array of windows wherein each symbol or image is determined individually, as provided herein. Accordingly, in one embodiment of the present invention a payline is formed by a pattern of symbols or images across columns of the window array, and in another embodiment of the present invention a payline is formed by a pattern of symbols or images across rows of the window array.

A pay-out of a prediction placed by a gamer on embodiments of the slot-machine as provided herein, takes place on an occurrence of one or more images or symbols inside a window of the array of windows that is displayed on the screen of the slot-machine, which preferably has a touch-screen display. The pay-out in accordance with one aspect of the present invention relies on the location of a window in the array of windows and on the symbol or image shown in that window. For instance, a pay-out takes place when a specific image or symbol appears in a specific window. In accordance with a further aspect of the present invention the level of pay-out depends on a specific image or symbol in a specific window of the array of windows.

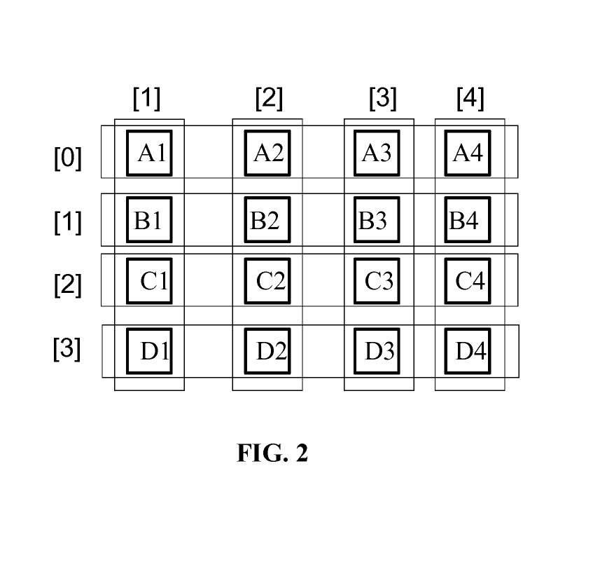

In accordance with a further aspect of the present invention a win and a related payout takes place when in a plurality of windows each has a specific image or symbol. This is illustrated in FIG. 2, which shows a part of a screen with an array of 4 by 4 windows, each window displaying an image or a symbol. The array has lines A1, . . . , A4; B1 . . . , B4; C1, . . . , C4; and D1, . . . , D4. One payline that pays out winnings is for instance, C1, C2, C3, C4; or diagonal A1, B2, C3, D4 or B1, C2, D3, C4. In the last case a “jump” of one row is allowed.

In accordance with a further aspect of the present invention a jump of more than 1 line is allowed as long as each column has a required image or symbol, such as A1, D2, B3, D4.

In accordance with an aspect of the present invention a payline is formed by every line having at least a required image or symbol. In accordance with an aspect of the present invention a payline or pay-pattern is determined by any other predetermined set of windows. For instance a “core” of windows B2, C2, B3, C3 may form a pay-out core when these windows have required images or symbols.

The present invention is not limited to any size of an array of windows and may be 5 by 5 or 10 by 10 or 5 by 10 or 10 by 5 or any array size that is useful for a slot machine. While the term window is used, it is intended to be a placeholder in an array on a screen to display images or symbols. When no images or symbols are displayed the window may have the same color as a screen background. It may also have a border or a color that distinguishes it from the background of the screen.

A pay-out or win depends on the appearing images or symbols in a pre-determined pattern, after the slot machine has been activated or played by a gamer. The gamer submits, or places an amount of money or credits before playing the slot machine. The gamer, through an input device, which may be buttons or controls, for instance on the touch screen may predict a pattern of windows and/or images or symbols that will appear as a result of activating the slot machine. The gamer may predict one window pattern on multiple window patterns or pay patterns. Each selected pay pattern may require an additional amount of money or credits or points.

It has been discussed above that the multi-window slot machine as provided in accordance with various aspects of the present invention, is a processor based machine with input devices and a display screen that may be a touch screen. The slot machine also has memory and/or other data storage devices such as a hard magnetic disk, optical disk or mass flash memory. The different pay-out patterns are stored in the memory or in the mass storage.

The pay pattern or patterns that are predicted by entering pay-lines or selections by the gamer are translated to for instance an address in a table. A table address can be formed in many ways. For instance, a gamer will have to push on 4 different windows of the window array of FIG. 2 to establish a pay pattern. A processor in a further aspect of the present invention decides if the entered pay pattern is a valid one. If not, the pay pattern is not accepted. If the selected pay pattern is valid as entered it is accepted and stored.

The selected pays pattern is stored in a memory, for instance assigned to a symbolic name like PayPat_1, which can be stored and retrieved. The predicted pattern may be stored as a named n by n array, wherein the required pattern is indicated by one symbol, for instance 1s, and all other windows are represented by 0s.

As an illustrative example, assume that a gamer predicts a first pay-pattern being required images or symbols in windows A1, B2, A3 and B4 as pay-line PayPat_1, which is then stored as:

| PayPat _1 | | | | |
|---|---|---|---|---|
| | 1 | 0 | 1 | 0 |
| | 0 | 1 | 0 | 1 |
| | 0 | 0 | 0 | 0 |
| | 0 | 0 | 0 | 0 |

When the slot machine is activated and the images or symbols are generated in the windows, the processor is aware that a pattern corresponding with PayPat_1 has been predicted. Each image or symbol in a window has at least one identifier that reflects a property of the image or symbol. The processor compares the values of the identifiers of the images or symbols in the windows that correspond to a 1 in the array PayPat_1: i.e. A1, B2, A3 and B4. In general, a slot machine requires that all images or symbols in a pay-line or pay-pattern are identical. In accordance with an aspect of the present invention that is not always required. However, in the embodiment wherein identical element are required, the processor checks if all elements are identical, or meet other winning requirements.

In one embodiment of the present invention, it is important which images or symbols have appeared in the required pattern to establish how much the winnings will be. For instance images or symbols may have a low value, causing a low pay-out or a high value, causing a high pay-out.

A gamer may select to predict several different pay-patterns. The processor stores or recognizes these different pay-patterns and checks against the selected pay-patterns of their occurrence in the play result. It is possible that more than 1 pattern occurs in the result. The processor then calculates a pay out based on preset criteria, like paying the highest, lowest or combined outcome.

In one embodiment of the present invention, the processor looks for a valid pay-pattern in the result after playing or generation of the images or symbols. This is a sorting problem that can be resolved in several ways. In accordance with an aspect of the present invention an image or symbol has to occur in at least each column of the array of windows. Each image or symbol has at least one identifier that has a value assigned to it. For sorting on the at least one identifier, the processor arranges the results of each column in an ordered column of identifier values, such as low to high or high to low. In a 4 by 4 array, the first column of images or symbols are then arranged in a column of low to high identifier value, wherein each value has a row position corresponding to its value. If there are 9 possible values, then a new arrangement column has 9 rows. A display array column on a slot machine has 4 rows.

The new arrangement thus has a column of 9 rows, wherein 4 rows in a column have a value not 0, while the remaining rows have a value 0. This translation is illustrated in the following example. Assume that a slot machine with a 4 by 4 window display generates images or symbols with the following identifier value.

| | | | |
|---|---|---|---|
| 9 | 1 | 2 | 3 |
| 2 | 4 | 2 | 9 |
| 7 | 9 | 8 | 6 |
| 3 | 5 | 9 | 2 |

Arranging the above array in a 9 row 4 column array will create:

| | | | |
|---|---|---|---|
| 0 | 1 | 0 | 0 |
| 2 | 0 | 2 | 2 |
| 3 | 0 | 0 | 3 |
| 0 | 4 | 0 | 0 |
| 0 | 5 | 0 | 0 |
| 0 | 0 | 0 | 6 |
| 7 | 0 | 0 | 0 |
| 0 | 0 | 8 | 0 |
| 9 | 9 | 9 | 9 |

Clearly, the images or symbols with identifier value 9 form a pay-line that would have required a pay-out if a pay-out would have occurred on identical valued images or symbols to occur in at least each column in a window array.

One can easily simplify the analysis of the long array, by identifying the non-zero elements in the first column and then checking if the next column in the same row is non-zero.

In a further embodiment of the present invention the actual row and column numbers in the window array are associated with the identifier value in the long array. This allows a reconstruction of the pay-pattern that corresponds to the occurrence of identical identifier values.

The above provides a visualization of determining occurrences of winning outcomes after activating the slot machine that is not based on actually entered pay-patterns by a gamer, but is a determination after the fact of activating. The translation array has many zeros that can be prevented by re-arranging the translation array. However, memory is nowadays relatively cheap and a 1000 by 1000 or even larger array of values each requiring several bytes of data would well be within available memory.

When the slot machine is activated to generate images or symbols, such generation takes place by using a random number, or a pseudo-random number, generator. Such a generator provides a number of which the occurrence appears to be random or almost random. In general, the occurrence of a certain number by activating should be according to a uniform or close to uniform probability distribution, so that each number has an equal probability of being generated. One may have to normalize a random number generator. For instance, a random number generator may generate with a uniform distribution a number on the interval [0,1). The slot machine may have to generate one out of 250 image with equal probability. In that case one has to normalize the [0,1) interval to a [1,250] interval. In general one has to normalize to an 1/n chance for equal chance of generating 1 out of n images.

In general, each image is generated independently and each of the images for the n by n windows on the display are generated from the same n images. Other random generating methods, with or without replacement, are known to one of ordinary skill and are envisioned to be applied in one or more embodiments of the present invention. The application of non-uniform probability distribution number generators is also known and is also applied in one or more embodiments of the present invention.

The present invention includes the use of a sports theme in a slot machine. A theme may relate to a specific sport, such as baseball, football, basketball, hockey (ice), soccer, boxing, golf, volleyball or any other sport wherein players can be rated according to their performance in a game. A theme may also relate to a combination of sports.

Names are collected from well known players, present and past, which may be called legends and about whom statistics are available about performance in specific games that have been played in the past. The statistics of these players are collected or determined according to preset rules. Examples how to rate a performance of a player in a game is explained in co-pending U.S. patent application Ser. No. 14/230,680 ('680 application) filed on Mar. 31, 2014 which is incorporated herein by reference in its entirety.

The '680 application describes for instance how activities of a Quarterback in Football are rated. For each passing yard 0.1 point per yard is awarded; 6 points for passing touchdowns; 0.1 points per yard for rushing yards; 6 points for rushing touchdowns; −2 points for an interception etc. (see specification of the '680 application as filed at paragraph [0156].) In the manner as disclosed in the '680 application, a total score for a player over a game is determined. This can be done for each player, for each game in each sport for which performances were recorded.

In accordance with an aspect of the present invention an image, or a symbol or a text is provided that represents a player in a sport. The representation of the player in one embodiment of the present invention is provided with a numerical value. For instance 250 football players either inactive legends or still active players are selected. Each player is identified by its playing position and by the team played for. Also more or less players may be selected and also players from different sports may be selected.

For each player a number of rated games is selected, or at least games wherein the performance of the player is rated and provided with a score. For instance from a career the five games with a high or highest score for a player, the five games with a low or lowest score are selected. One may also select the 5 first games of a period and the 5 last games of a period of for instance 10 years for a player. The games are placed in a table. It should be clear that other numbers and other selection criteria can be applied.

Each image of a player is provided with at least one unique identifier, usually the player's name. However, this can also be a unique number. Furthermore, each player, and thus each image of a player, is also provided with a sport. Furthermore, a number of games scored for the player is selected and stored. For each game of the player, the name of the team of the player, the date of the game, a score for the team in the game, the outcome status of the game (win, lost, equal score or tie), and the opponent of the team are all provided and associated with the image of a player. Other properties can also be associated with an image.

In accordance with an aspect of the present invention, a plurality of games for a single player is stored in a memory. In accordance with an aspect of the present invention, calculated or determined properties of a player are also stored and associated with the player. For instance, a highest and lowest and an average score of the stored games are determined and stored. Also a highest and a lowest and an average score of a season are determined and stored. Also a highest and lowest and an average score of a professional career of the player are determined and stored.

The specific games are identified by date of the game and by the score of the player in that game. One may also identify the game by the opponent and the date and the score, or any other identification that is useful. Each player can be selected by running a random number generator. In accordance with an aspect of the present invention also a random generator can be applied to select one of the games of the players from its table. As a result, one can generate a representation of a player on a display of a slot machine. By performing an extra step of selecting a game at random, one may also provide a representation of a player in a specific game and the player's score in the specific game. In accordance with an aspect of the present invention an average score is provided for the performance of the player. In one embodiment of the present invention the average score is determined over a lifetime or over a fixed period, and preferably a multi-year score average. In another embodiment of the present invention the average score is determined from the number of games stored in the table. In accordance with an aspect of the present invention, the games in the table are changed after a certain number of times the game is played or after a session on a slot machine has ended.

The slot machine, in accordance with an aspect of the present invention, can be operated and played in different modes, with different sports, different players, different positions, different teams and different periods of time. A mode may require a single sport, a single player, a single team, a predetermined score, a predetermined period, or a mixture of these elements.

One of several advantages of applying a score of a specific player in a slot machine is that a slot machine can be played in a mode wherein knowledge of a sport increases the chance for a gamer to win a slot machine game. Furthermore, smart game strategies may also increase chances for winning. So rather than being a mere chance device, the slot-machine as provided in accordance with various aspects of the present invention, is a knowledge driven gaming device.

A round is the generation of images or symbols by the slot machine for the array of windows of the display of the slot machine that takes place after a gamer activates the slot machine to generate a display the images or symbols by using a random number generator. The activating may take place after a gamer places one or more bets, which may involve for instance selecting one or more pay-out patterns and selecting a number of points or credits or the like that is to be placed on a predicted outcome. This generating of images or symbols after activation of the slot machine may be called a round.

A game may be playing a single round by placing an amount, possibly including selecting a playing mode and one or more pay-out patterns or by running a standard, straight across payline prediction. The processor decides is an outcome includes a winning payline and provides the earned winnings either as coins or tokens or adds to the credit of the gamer. Each new round is also a new game in this situation. So each game is a single round game in this mode.

In accordance with another aspect of the present invention a game can be a multi-round game. In a multi-round game after generating the results of a first round, the gamer is offered the opportunity to selectively hold a generated image in one or more windows in the array of windows. In accordance with various aspects of the present invention that can be a single window, or a plurality of windows, or a plurality of windows in a single row or column, or a complete row of column of windows, or any window in the array of windows, but never more than n*(n−1) windows in the array of windows, or all windows. A payment may be required to place an image in a window, or a row or column of windows on hold. A payment may be required for each window, or a payment for a row or a column or a payment for a maximum number of windows.

In accordance with an aspect of the present invention, a mode of playing is selected by a gamer, for instance via the touch screen or with an input device such as a mouse or any other input device that is useful for providing input to the slot machine. In one embodiment of the present invention the display screen provides a menu or choices on the screen. For instance a starting screen after a welcome screen, may offer a choice of playing modes. Playing modes are based on a selection of parameters or properties.

One playing mode provides a pay-out on a selected pay-line wherein all players have at least one common parameter. For instance, all players are selected from a single sport, which as an illustrative example is football. A payline is selected on the screen by a gamer. The gamer also selects the play mode “common parameter.” A common parameter then is:

1) all players on the payline are from the same team;
2) all players on the payline are in a same players position;
3) all players on the payline have the same score for the drawn game;
4) all players on the payline are in a game played on the same date;
5) all players on the payline are in a game with a same game status (win, lost, equal score or tie);
6) all images on the payline are of the same player, or
any other property that is associated with a player's image.

A payout is provided based on an occurrence of one or any other similarities as explained above. Because each image has so many variables, the game of predicting an outcome based on a sport is much more interesting then with images representing playing cards, for instance.

In another mode of the slot machine, in accordance with an aspect of the present invention, at least one further variable of the images is fixed. For instance, all images are from a single sport of a player in a particular position. For instance, all images are selected from Quarter Back (QB) players in Football. In one embodiment of the present invention, all images are from a single QB in different games. The game challenge of a gamer on the slot machine, is then to predict an outcome of an activation result.

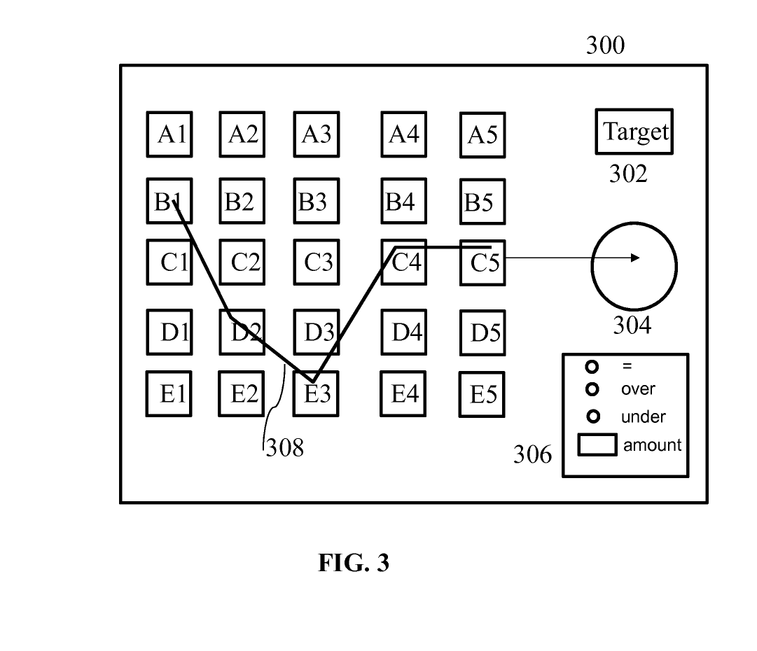

This is illustrated in FIG. 3 showing a display 300 of a slot machine. A mode of the slot machine is selected separately and is not shown in FIG. 3. However, the selected mode requires from a gamer to select a payline and to provide a prediction of a score on the payline. The display screen in this illustrative example has 5 by 5 windows to display, based on a random number generator, 25 images displayed in 5 rows and 5 columns. In this case the gamer predicted a payline 308. This can take place by touching the locations of the windows on the display screen if the screen is a touch screen. One may also use a mouse or any other cursor control to provide a payline.

The slot machine may require a single payline. The slot machine may also offer the opportunity to select multiple paylines. The selected mode in this case also requires a prediction of a score. It may be that the generated images are of a single QB selected from a career long number of games. The gamer needs in that case to predict a score that is compared with the scores associated with the generated images. In one embodiment of the present invention a gamer select a target 302 from a list of targets, for instance a list of QBs. In one embodiment of the present invention an image of the target is provided, but no specific game. For instance, a gamer selects Peyton Manning as a target. The gamer in an input part 306 also provides a prediction. The prediction can be that the generated game for Peyton Manning matches a highest score of a generated image on the payline, or is higher or is lower than the highest score in a payline. In one embodiment of the present invention one can also predict at least one matching score of a player in the payline through the choice “amount” in 306.

In one embodiment of the present invention, the slot machine is activated and the images are generated in their respective windows. Also the game and the score of the selected target player in the game is generated. The processor in the slot machine checks the selected payline if the predicted players and or games have been achieved. The processor then determines the highest or lowest score and checks this against the prediction in 306. In one embodiment of the present invention the processor displays the score result of a payline in a result window 304. If the prediction was correct, a payout follows.

In one embodiment of the present invention an “insider option” is offered in which a gamer, preferably for payment, is notified of the score of the target in the selected game prior to activation. This means that with selecting a target, prior to activation, the game of the target is already selected but the score has not yet been displayed. After payment, the score of the player in the selected game is provided. The gamer is allowed to generate a new target score or stay with the already selected score.

In a further embodiment of the present invention, the insider option is extended to the displayed images in the array of windows, which display the games but not the score of the player in that game or the outcome of the game. In that case the gamer may decide to generate a new set of images. In a further embodiment of the present invention, the gamer selects the payline based on the generated images and selects a target image based on the generated images. In a further embodiment of the present invention, the gamer then chooses a prediction of over/under and possibly by what number. After selection, the score is displayed for each image. Clearly, this way of playing favors the gamer who is familiar with a sport.

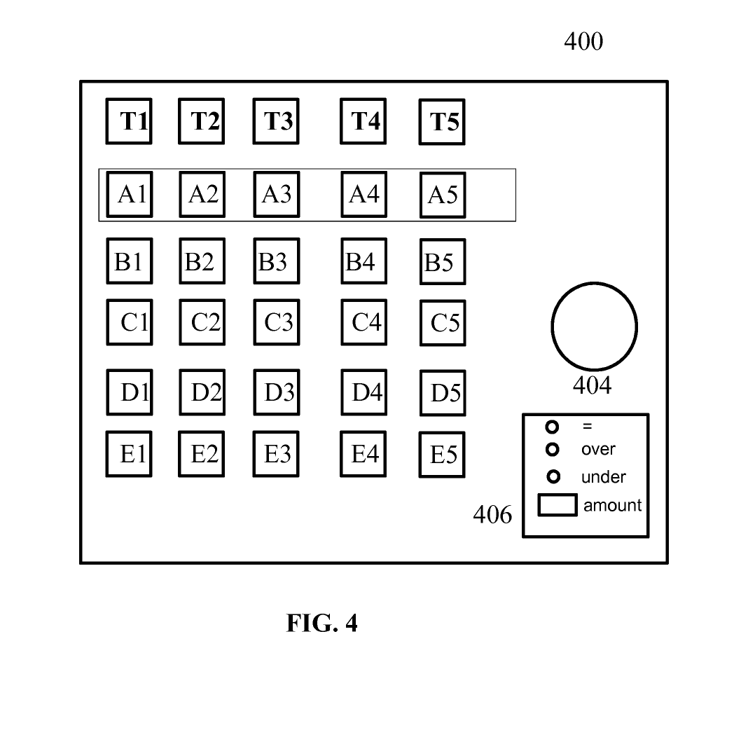

In yet a further embodiment of the present invention, a selection is to be made from different positions in a team. For instance, as illustrated in FIG. 4, each column in the array of windows represents a different position in a football team. A gamer selects for each column a preferred player, wherein for instance T1 is the QB, T2 is a Running Back, T3 is a Wide Receiver, T4 is a Tight End, and T5 is a Kicker. The slot machine generates upon activation the games and if no insider option is selected, a score for the selected players. The processor also generates in each column a player and a game for that player in the position that corresponds to that column.

In one embodiment of the present invention, at least one payline has to be selected by a gamer and a prediction of how the combined score of the T row (T1, . . . , T5) compares to the combined score of the payline. In another embodiment of the present invention only a simple payline is considered, like the payline A1, . . . A5. The gamer selects the Legends for T1, . . . , T5 and predicts an outcome against the to be generated players in the payline. A gamer may use an insider option to look at the scores of the games of the selected players. The gamer then activates the slot machine, which will select the players and the games for each window. The processor calculates the total score over a payline and compares it with the total score of the T-line (T1, . . . , T5).

In general a payline extends over all columns. In accordance with an aspect of the present invention, a payline is any predetermined pattern of images or symbols on the display screen that leads to a pay-out, unless indicated otherwise. A payline can thus also be a pattern of images or symbols across rows in the array of windows. A payline can also be formed by a patterns like B2, B3, C2, C3 in FIG. 2. This may be called a core pattern. For instance a payline is the core B2, B3, C2, C3 wherein the core must have 1 QB, 2 WR and 1RB in football.

It should be clear that the structure of the slot machine as provided in accordance with various aspects of the present invention offers many possible variations for set-up and playing. In accordance with an aspect of the present invention the numbers of rows of the array of windows is set between 1 and n, with n being an integer greater than 1. In accordance with an aspect of the present invention the numbers of columns of the array of windows is set between 1 and n, with n being an integer greater than 1. Preferably, the array of windows is an n by n square. However it can also be an n by k or an k by n rectangle with k smaller than n. By increasing the number of columns opportunity for a successful payline is made more difficult. By increasing the number of rows, opportunity for a successful payline is potentially made easier.

The probability of occurrence of an image can be managed by the size of the group of images (or games) that is selected from and the number of legends that is selected from and the number of games per legend that is selected from.

Another way to influence the probability of occurrence is to use a random but fixed order of players, so that for instance the columns in the array of windows represent a fixed order of players, which makes the selection of multiple paylines more attractive, as an occurrence of a player in a column is now a “drawing without replacement.” A player can and in many cases of different embodiments of the slot machine will appear multiple times on a reel. The “size” of the reel can be a fixed size, but can also be set by a gamer or by a selected mode prior to playing a game on the slot machine by the gamer. In one embodiment of the present invention no concept of a reel is applied and an image for a window is generated individually. One can also determine a number of teams, a number of sports and any other parameter that can influence a probability of an occurrence of an outcome.

In one embodiment of the present invention the display screen has a window array of 3 columns and 1 or more rows. In case of one row, no payline has to be selected as only one line of images occurs. In case of 2 or more rows, a player can select 1 or more paylines. In one embodiment of the present invention a win, or a no-loss, takes place on an occurrence of 3 images of a particular legend player on a payline. A pay-out or an additional pay-out occurs when the gamer correctly predicts a score or a total combined score on the payline. A gamer predicts one or more of a highest total, a range, a match, a lowest total, a single game match in the series of games in a payline or predicts that a number provided is higher, lower or equals a total, or predicts that a number provided is not exceeded by the highest score in the payline of scores or that the number provided is lower than any other score.

Clearly, the above requires some preset conditions. For instance a lowest allowable number needs to be set as well as a highest possible number. These preset numbers may be derived from the actual scores of the players. For instance a Legend QB Football Player may have a lowest game score of 11 and a highest of 28 for another season. The score depends on how the score is calculated and may vary with the method that is applied. Clearly, a prediction that the QB's score is greater than 10 or less than 29 is not acceptable as being always true. One way to determine an “over-under” range is to arrange the determined scores in ranges, for instance over 19 and 19 and under. One can make other ranges, like 4 ranges: [11,15], [16,19], [20,23], [24,28]. One can of course create any number and type of ranges as desired.

In a further embodiment of the present invention, a range is determined from the lowest score of all players and the highest score of all players. Because of the different activities of players in different positions their scores will be in different ranges. In one embodiment of the present invention, one will keep the different scoring types. A combined score over a payline is a simple addition of all the individual scores.

In one embodiment of the present invention different positions or players in different sports are to be compared or combined. A very good football player may achieve 35 points in a game as best performance. A very good player in another type of sports may achieve 149 points as a best performance. Such differences may not be meaningful if one considers only one sport. However, if one has a payline wherein players of different sports are to be considered, then some type of normalization may be desirable. To a lesser extent, the need for comparison also applies for different positions in a team sport, wherein the actual score of a good player may be substantially different, even if both had a score in the top of its respective range.

In accordance with an aspect of the present invention, a score of a player is normalized to a common base score. A common base score may be a score of 1-100 for instance. A lowest score of all players in a certain position is set at 1 and the highest score is set at 100. So the QB score of 11 is then transformed to 1 and 28 is set to 100 (assuming that these are the lowest and highest scores for all QBs). So the transformation is then: norm=(pos−11)*99/17+1 for the normalized score for the QB position in football from the actual score “pos.” Such a normalization allows further interesting plays by a gamer. For instance, a slot machine may accept a setting of defensive football players in line T1, . . . , T5 in FIG. 4, including using a review by a gamer by using an “insider option.” Based on the strength of the normalized score of the defense team in T1, . . . , T5 the gamer may provide a prediction of an offensive team on a selected payline.

In accordance with an aspect of the present invention, the slot machine as provided herein in accordance with various aspects of the present invention is a static or stand-alone machine that is operated on a fixed location, for instance in a gaming hall. In a further embodiment of the present invention, the gaming machine is an application that runs on a computer, for instance a mobile computer, such as a laptop computer, a tablet computer or a smartphone.

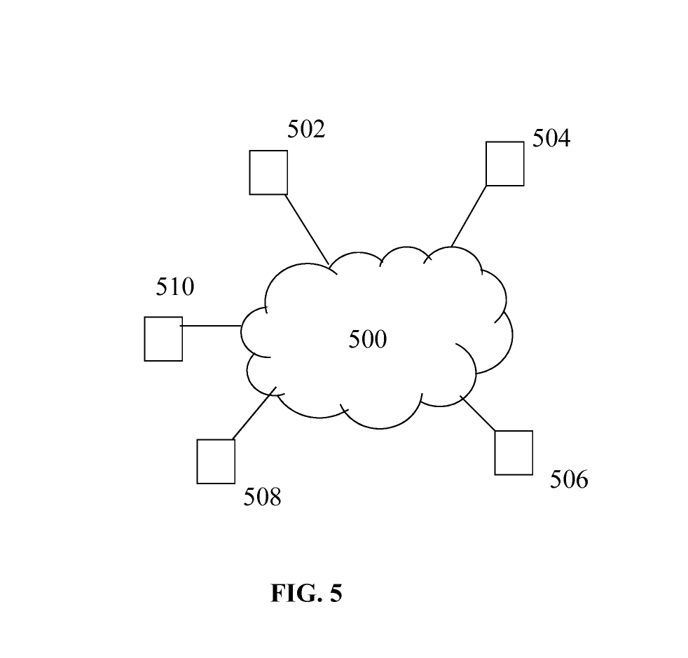

FIG. 5 shows a client computing device or gaming device 502 connected via a network 500 to a server 504. The network 500 is preferably the Internet. The connection between the network and the devices is a wireless or a wired connection. The computing device 502 may be used to download a slot machine software application from the server 504 to be installed and operated on client 502. A client computing device 508 may communicate with the server 504 for managing one or more functions of the server. The slot machine software application may be provided to 502 with different possible functionalities. In a first embodiment the software application may be a single row 3 column slot machine program, related to a single sport with a limited number of games. Different other versions or models, which may be acquired for a payment, have larger databases of games and players, and also the ability of larger number of windows in the window array for the display screen. In its simplest form, the slot machine may be offered for free. In that form it is also a learning tool for a gamer to learn the possibilities of the slot machine and how to apply the statistics of a game such as a football game. The network connections are also used to update the gaming device with new or corrected data.

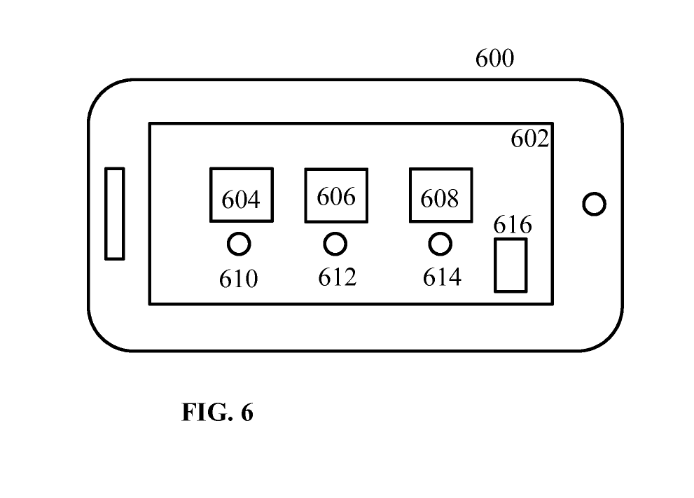

FIG. 6 illustrates a single line 3 column Legend Fantasy Sport slot machine on a smart phone 600 with a display touch screen 602. It has the simple single line (1 by 3) windows, with a single payline 604, 606, 608. It has activation buttons 610, 612 and 614 and a menu, data entry box 616. Preferably, there is a HELP screen that can be activated that is not shown. The HELP screen provides the details on using the slot machine and ways to view the statistics and details of the stored images and related parameters.

A computing device is a device with a processor or other circuitry that is configured to execute instructions. A computing device also has memory or other data storage means to store and retrieve data. A computing device as disclosed herein also has communication circuitry to connect to a network. A computing device operated as a client also has an input device such as voice, camera, touch screen, a mouse or a key-board and an output device such as a display screen. Examples of computing devices are a personal computer, a laptop computer, a server, a tablet computer, a smartphone and a portable phone.

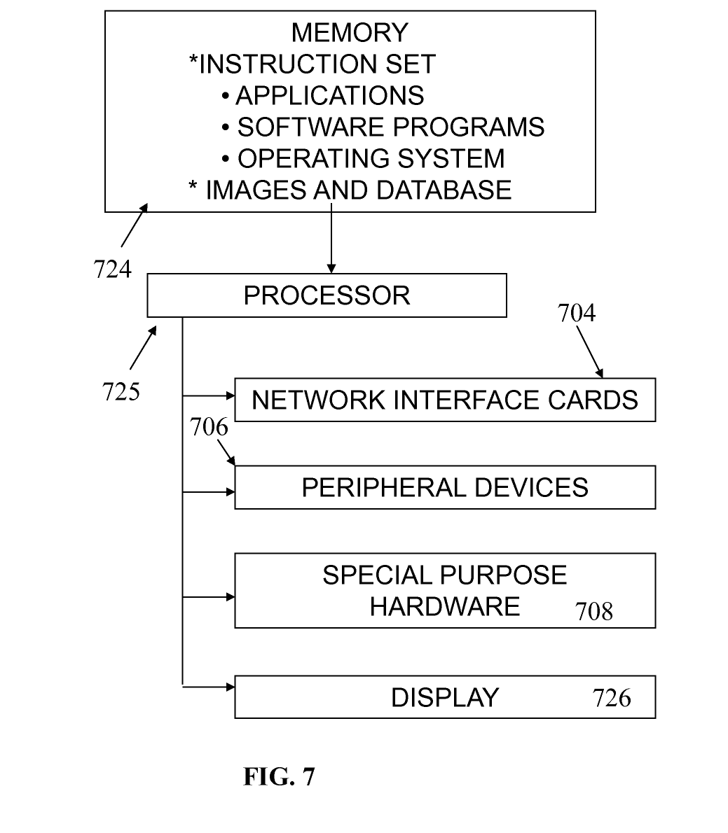

FIG. 7 illustrates a computing device that is part of a fantasy legend game system as provided herein. The servers and the computing stations include storage and memory devices 724 to store data and instructions that can be retrieved from 724 by a processor 725, a display 726 which is preferably a touch screen, input devices and other peripheral devices and input/output ports 706, and network connection devices such as network interface cards 704. Special purpose hardware 708 may also be included. Each of the processes and steps described herein are implemented using the processor 725 and the storage 724 and any required ancillary device that form the responsible part of the computing systems of the present invention. Any number and any arrangement of computing systems can be used to implement the present system. Any of the methods and steps described herein can be implemented using the computing system including the computing device of FIG. 7. Additionally, any of the methods and steps described herein can be implemented on any of the processors in any of the processor based devices illustrated in FIG. 7.

A processor in accordance with an aspect of the present invention is a programmable processor, which contains and execute instructions that perform the steps as provided above. When the instructions are executed by the processor, a device with a display screen as provided above in accordance with various aspects of the present invention, acts as a mechanical slot machine with additional and novel features. In one sense such a slot machine in a large housing is in one embodiment of the present invention indistinguishable from a mechanical slot machine.

The processor in one embodiment of the present invention is programmed with a programming language such as Java or C++ or C# or any other programming language that generates executable instructions for the processor that are stored and retrievable by the processor to be executed. When these instructions are executed, input data is received images and other data are displayed on the display screen and a score is determined, making the device look and act as a dedicated gaming machine or slot machine with unique and novel capabilities. The impression of the machine being mechanically enabled is enhanced by providing a mechanical feedback mechanism and by showing different images passing through a window as if a rotating reel is being used. The mechanical mechanism in one embodiment of the present invention is a motor or actuator, such as a motor with an eccentric weight on a rotatable axis, or a motor with a piston-like axis that moves between stable positions to provide impulse like movements, or any device that provides an impression of a rotation being started or stopped. Activating or deactivating one or more of these motors or actuators provides an illusion of a reel being started or a rotating reel being stopped. This provides an impression to a gamer that actual reels are being rotated and stopped. Very small motors are currently available for integration in a housing of a smartphone. The actuators may be activated per window, per row or per column. This is done preferably concurrently with displaying a result in a window. In yet a further embodiment of the present invention there is a time delay between displaying the results of the different windows. For instance, results are shown from left to right, building up excitement and expectations of what the final result will be and making playing the slot machine of the present invention more engaging. In accordance with an aspect of the present invention, the windows that do not yet provide a result may be blurred or show moving images, thus providing an illusion of a rotating reel.

The use of a programmable processor is generally beneficial to allow to change a functionality of the slot machine, for instance by changing the number of reels or adding or removing players and/or games played. In absence of a need to change or adapt to changing circumstances, a slot machine provided in accordance with one embodiment of the present invention is a dedicated and customized machine realized with fixed and generally difficult to modify circuits, including fixed digital Field Programmable Gate Arrays (FPGAs) that have a fixed control of FPGA gates to execute a single embodiment.

While there have been shown, described and pointed out fundamental novel features of the invention as applied to preferred embodiments thereof, it will be understood that various omissions and substitutions and changes in the form and details of the methods and systems illustrated and in its operation may be made by those skilled in the art without departing from the spirit of the invention. It is the intention, therefore, to be limited only as indicated by the scope of the claims.

1. A gaming device, comprising:
a memory, that stores a first plurality of images, each image of the first plurality of images is representative of a single player in a sport, and instructions;
a processor, that executes instructions retrieved from the memory;
an input that provides prediction data to the processor and that activates the gaming device;
a display screen that is controlled by the processor to display a second plurality of images arranged in an array of rows and columns, the second plurality of images on the display screen selected by the processor from the first plurality of images, the display of the second plurality of images being initiated by an activation of the gaming device;
each single player is associated with a plurality of parameters that includes: a name of the single player in the sport, a plurality of games in the sport wherein the single player has played, a position of the single player in the plurality of games, a game score of the single player in a game in the plurality of games and a date that the game was played;
each image in the second plurality of images is selected randomly from the first plurality of images and each randomly selected image is provided with a game randomly selected by the processor from the plurality of games in the sport wherein the single player has played;
a prediction of an outcome score that is provided to the processor and that is based on a predicted arrangement of a subset of the second plurality of images in the array;
a determined outcome score determined by the processor, based on the game score of each single player of the images in the subset of the second plurality of images; and
a winning determined by the processor based on a comparison of the prediction of the outcome score with the determined outcome score.

2. The gaming device of claim 1, wherein:
the outcome score is determined by combining the game score of the single player in each image in the arrangement of the subset of the second plurality of images in the array.

3. The gaming device of claim 1, wherein:
the outcome score is determined by comparing at least one of the game scores in the arrangement of the subset of the second plurality of images in the array with the prediction of the outcome score.

4. The gaming device of claim 1, wherein:
a winning combination is determined when all images in the arrangement of the subset of the second plurality of images in the array are images of the same single player.

5. The gaming device of claim 1, wherein:
a winning combination is determined when all images in the arrangement of the subset of the second plurality of images in the array are images of single players in a same team.

6. The gaming device of claim 1, wherein:
a winning combination is determined when all images in the arrangement of the subset of the second plurality of images in the array are images of single players in a same playing position.

7. The gaming device of claim 1, wherein:
an array of rows and columns has at least 3 columns.

8. The gaming device of claim 1, wherein:
an array of rows and columns has at least 5 columns.

9. The gaming device of claim 1, wherein:
the arrangement of the subset of the second plurality of images in the array is formed by at least one image location in each column.

10. The gaming device of claim 1, wherein:
the arrangement of the subset of the second plurality of images in the array is formed by at least two image locations in at least one column.

11. The gaming device of claim 1, wherein:
the first plurality of images is arranged in a plurality of reels of images, each reel representing images that are enabled to be displayed in a column in the array.

12. The gaming device of claim 1, wherein the gaming device is a stand-alone slot machine.

13. The gaming device of claim 1, wherein the gaming device is a smartphone.

14. The gaming device of claim 1, further comprising:
an actuator that is activated when an action on the display screen is started.

15. A slot machine, comprising:
a memory, that stores a first plurality of images, each image of the first plurality of images is representative of a single player in a sport, and instructions;
a processor, that executes instructions retrieved from the memory;
an input, the input provides prediction data to the processor and the input activates the slot machine to execute a slot machine game;
a display screen that is a touch screen that is controlled by the processor to display a second plurality of images arranged in an array of rows and columns, the second plurality of images on the display screen selected by the processor from the first plurality of images, the display of the second plurality of images being initiated by an activation of the gaming device;
each single player is associated on the memory with a plurality of parameters that includes: a name of the single player in the sport, a plurality of games in the sport wherein the single player has played, a position of the single player in the plurality of games, a game score of the single player in a game in the plurality of games and a date that the game was played;
each image in the second plurality of images is selected randomly by the processor from the first plurality of images and each randomly selected image is provided by the processor with a game that is randomly selected by the processor from the plurality of games in the sport wherein the single player has played;
a prediction of an outcome score that is based on a predicted arrangement of a subset of the second plurality of images in the array and that is provided by the input prior to the activation;
a determined outcome score that is determined by the processor based on the game score of each single player of the images in the subset of the second plurality of images; and
a winning that is based on a comparison of the prediction of the outcome score with the determined outcome score.

16. The slot machine of claim 15, wherein:
the first plurality of images is arranged in a plurality of reels of images, each reel representing images that are enabled to be displayed in a column in the array.

17. The slot machine of claim 16, further comprising:
an actuator that is activated when a reel in the plurality of reels stops rotating.

18. The slot machine of claim 17, wherein the slot machine is a smartphone.

19. A method for operating a slot machine, comprising:
inputting on an input of a processor prediction data;
activating the processor to perform the slot machine;
randomly selecting by the processor from a first plurality of images a second plurality of images that are displayed on the touch screen arranged in an array of rows and columns, each image of the first plurality of images represents a single player in a sport and is associated with a plurality of parameters that includes: a name of the single player in the sport, a plurality of games in the sport wherein the single player has played, a position of the single player in the plurality of games, a game score of the single player in a game in the plurality of games and a date that the game was played;
the processor providing each randomly selected image in the second plurality of images with a game randomly selected by the processor from the plurality of games in the sport wherein the single player of the randomly selected image has played;
the processor accepting, prior to the activation, a prediction of an outcome score that is based on a predicted arrangement of a subset of the second plurality of images in the array;
the processor determining an outcome score, based on the game score of each single player of the images in the subset of the second plurality of images; and
the processor determining a winning based on a comparison of the prediction of the outcome score with the outcome score.

20. The method of claim 19, wherein:
the outcome score is determined by combining the game score of the single player in each image in the arrangement of the subset of the second plurality of images in the array.
